(19) United States
(12) Patent Application Publication
(10) Pub. No.: US 2025/0201086 A1
(43) Pub. Date: Jun. 19, 2025

(54) SYSTEM AND METHOD FOR SMART DOORBELL INTEGRATION

(71) Applicant: Wyze Labs, Inc., Kirkland, WA (US)

(72) Inventor: Hang Zuo, Kirkland, WA (US)

(73) Assignee: Wyze Labs, Inc., Kirkland, WA (US)

(21) Appl. No.: 19/068,341

(22) Filed: Mar. 3, 2025

Related U.S. Application Data
(63) Continuation of application No. 17/657,671, filed on Apr. 1, 2022, now abandoned.
(60) Provisional application No. 63/300,682, filed on Jan. 19, 2022.

(51) Int. Cl. G08B 3/10; G08B 13/196; H04M 1/02; H04M 11/02

(52) U.S. Cl. CPC G08B 3/10; G08B 13/19684; H04M 1/0291; H04M 11/025

(57) ABSTRACT

A smart doorbell system suitable for installation within an existing conventional doorbell system is provided which controls the flow of current without any leakage using one single pole dual throw switch selecting between the doorbell chime and a bypass. By presenting current from passing through the existing chime during normal operation, the smart doorbell can be powered at almost all times using the home's existing transformer. Only when the smart doorbell's button is pressed will the current be temporarily diverted to the existing chime so as to enable it to emit the desired notification sound. A small battery can provide power to the smart doorbell during the few brief periods when the doorbell is powered and thus no power is provided to the smart doorbell from the home's transformer.

### CROSS-REFERENCE TO RELATED APPLICATION

This application is a continuation of U.S. patent application Ser. No. 17/657,671, filed Apr. 1, 2022 which claims the benefit of U.S. Provisional Application No. 63/300,682 filed Jan. 19, 2022, which is hereby incorporated by reference to the extend not inconsistent.

### FIELD OF THE INVENTION

The present invention herein pertains to doorbells requiring a power supply and particularly pertains to a smart doorbell system for installation in a conventional setting while efficiently maintaining operation of the existing doorbell chime and also enabling operation of a digital chime.

### BACKGROUND OF THE INVENTION

Doorbells have been in existence in one form or another for nearly 200 years and have traditionally severed the sole purpose to enable visitors to announce their presence. FIG. 1 schematically illustrates a conventional doorbell system 100 which has been the standard for many many years. The doorbell system 100 includes a stepdown transformer 102, a user manipulatable doorbell switch 104, and a mechanical doorbell chime 106. A primary winding 108 of the transformer 102 is electrically connected to an alternating current (AC) electrical power source (not shown), such as a conventional nominal voltage line (i.e. 120 V), and a secondary winding 110 of the transformer 102 is electrically coupled in series with the doorbell switch 104 and the doorbell chime 106 by electrical conductor line 112.

With the exception of the doorbell switch, the components of doorbell system 100 are typically mounted within the home. The doorbell chime is mounted outside the home and adjacent to a point of entry, such as the front door. In its normal state, the doorbell switch 104 is open, and electrical current therefore does not flow through the doorbell chime 106. While not shown for simplicity, the doorbell switch 104 often includes a button for the user to press which temporarily activates or closes the switch 104. When this button is pressed, the doorbell switch 104 is momentarily closed, and electrical current flows through the line 112 and energizes the doorbell chime 106. In the case of a convention doorbell chime 106, which is an electro-mechanical, this current actuates one or more solenoids or plungers 114 to strike a first metal plate or resonator 116, which produces a “ding” sound. When the doorbell switch 104 is released by the user such that the switch returns to its open position, the solenoid or plungers 114 of the doorbell chime 106 strikes a second metal plate or resonator 118 having a different (and often lower) pitch, thereby producing a “dong” sound. It shall be appreciated that the prior art doorbell system 100 is shown absent certain details to promote illustrative clarity. In other forms, an electronic doorbell device may be utilized in place of doorbell chime 106.

With the evolution of the Internet and wireless capabilities so called “smart” doorbells have begun to replace convention doorbells of the type shown in FIG. 1. These smart doorbells often include the ability to notify the homeowner of a visitor through their mobile device or in some other manner, either in addition to or in place of using the conventional chime. However, given the number of existing homes having conventional doorbell systems, a design was needed to enable smart doorbells to be retrofitted into existing homes, as they have different requirements. Given that smart doorbells require continuous power, the conventional arrangement was not suitable for their use.

One solution was to power the smart doorbell via a self-contained battery. This solution has some advantages, but batteries typically do not perform well outdoors, and even in optimal conditions require periodic recharging. Another solution would be to re-wire the house to provide a continuous power source for the smart doorbell, but this requires additional wiring to be ran, which in a finished space such as an existing home, this can be a very time consuming and expensive option. Yet another solution was to simply eliminate the existing chime from the system, by disconnecting it or otherwise mooting its function, so that continuous power could be provided over the existing wiring to the smart doorbell. A separate new chime would be utilized, such as a chime which communicated with the smart doorbell via wireless communication and receives its power from an existing wall outlet inside the home.

Despite the above identified solutions, many simply prefer the case of installation, responsiveness and simplicity of maintaining much of their existing doorbell system. Nevertheless, to avoid requiring a battery for all the smart doorbell's power requirements, some power must be provided from the transformer. However, one simply cannot always provide power over the line so as to power the smart doorbell as then the doorbell chime would constantly ring. As a result, several designs have been developed to utilize the existing chime yet still provide power to the smart doorbell.

One such prior art design is described in U.S. Pat. No. 10,708,404 which describes the use of two or three separate switches to control and divert the current between an existing doorbell chime. One or more switches controls the current flow to the chime while the other disconnects the short circuit path which allows current to flow around the chime. By selectively controlling these switches the chime can be bypassed when desired and powered when needed.

Yet another design to address this issue is provided in U.S. Pat. No. 10,999,505. This design utilizes a shunt device which is connected in parallel with the existing doorbell chime. In normal operation the shunt device is in a low impedance state which allows sufficient power to be run over the lines to power the smart doorbell while only allowing minimal current to flow through the existing doorbell chime and therefore prevent it from being activated. Upon detecting that the doorbell button is pressed, the shunt device transitions to a high impedance state which directs most of the current through the existing chime enabling it to activate and alert as intended before subsequently returning to its normal state.

More complex designs also exist which seek to utilize alternative signaling on the existing wires in order to selectively provide power to the existing chime. For example, see the design(s) provided in U.S. Pat. No. 10,304,296.

The aforementioned designs allow for the use of much of an existing doorbell system, such as doorbell system 100, which are ubiquitous in existing U.S. homes in supporting a smart doorbell. However, these designs still suffer from numerous drawbacks, including circuit complexity, current leakage, malfunctions and other issues.

What is needed is a simplistic design which is easy for the user to install and configure and also provides the desired operation for a smart doorbell being integrated into an existing doorbell system and maintain operation of the existing chime. In addition, when operation with an digital chime is preferred, better there may also be achieved.

### BRIEF DESCRIPTION OF THE DRAWINGS

FIG. 1 is a plan view of a conventional doorbell system of the prior art which is commonly found in existing homes.

FIG. 2 is a logical view of one embodiment of a smart doorbell for use with the present invention.

FIG. 3 is a plan view of a smart doorbell system according to one embodiment of the present invention.

FIG. 4 is a detailed plan view showing the connection of certain components of the smart doorbell system according to the embodiment shown in FIG. 3.

FIG. 5 is schematic view showing the elements of a chime controller according to one embodiment of the present invention and its connection to certain components of the smart doorbell system according to the embodiment shown in FIG. 3.

FIG. 6 is a logical view of a further embodiment of a smart doorbell for use with the present invention.

### DETAILED DESCRIPTION OF THE SPECIFIC EMBODIMENTS

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In certain embodiments of the present invention, a smart doorbell and its associated system for integrating into an existing conventional doorbell system while maintaining the function of the existing doorbell chime is disclosed. The resulting smart doorbell system includes the smart doorbell, existing doorbell chime, chime controller and the existing home transformer for powering the system. While the smart doorbell may be configured in numerous forms, including various functions and features, for purposes of illustration a typical configuration will be illustrated.

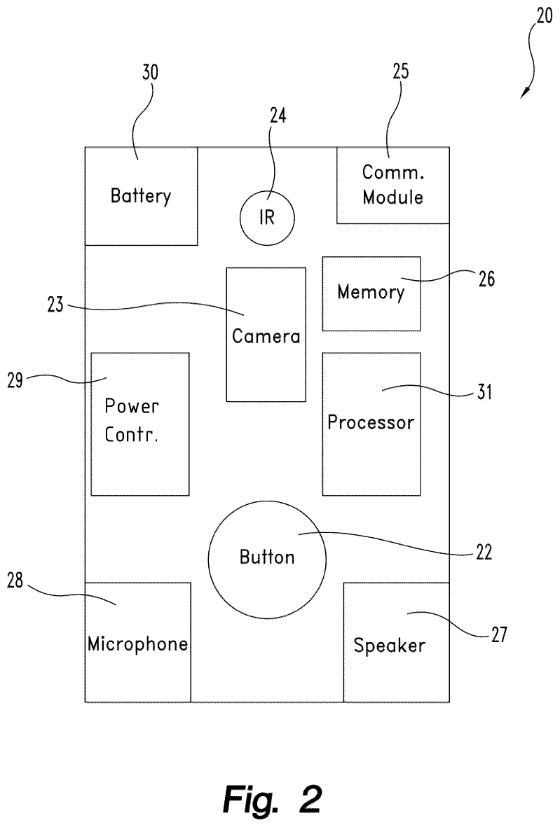

Illustrated in FIG. 2 is a logical view of one embodiment of a smart doorbell 20 for use with the present invention. Smart doorbell 20 includes an exterior housing 21, which provides weatherproofing for all of the internal components shown as well as a pleasing aesthetic appearance. Smart doorbell 20 also includes a user manipulatable button 22 which is accessible from the exterior of housing 21. This button will be recognized by a visitor to replace the tradition button of an existing conventional doorbell which serves to notify the occupants of the home of the user's presence. As additional features, smart doorbell 20 includes an outward facing camera 23 which protrudes through the exterior housing 21 so as provide a view of the porch, driveway or other area adjacent to door where the smart doorbell 20 is mounted. The smart doorbell 20 may also include an infrared emitter 24 to work in conjunction with the camera 23 to provide night time visibility. To enable communication with the remote user via their smartphone, as well as to provide many other known features such as cloud storage of images and recordings, smart doorbell 20 includes communication module 25, which may be a wi-fi interface, cellular interface, Bluetooth interface or the like. Also included to assist in operation, caching of information prior to communication, or for longer term storage for subsequent retrieval, smart doorbell 20 may include a memory 26, which may be of a variety of different sizes and formats depending upon the functionality and capacity desired. To enable richer interactions with visitors, especially when the homeowner is away, smart doorbell 20 may also include a speaker 27 and a microphone 28 which may enable two-way communication between the homeowner and the visitor, to provide sound access and recording whenever the homeowner wishes or whenever certain triggering events are detected. As will be described below, smart doorbell 20 also includes power controller 29 for intelligently managing power distribution within smart doorbell 20 as dictated by current operating state and battery 30 for providing power various other components of smart doorbell 20 when needed. Finally, smart doorbell 20 includes process 31 which supports and controls the operation of all of the remining components as well as the flow of data and signals therebetween to ensure that smart doorbell 20 operates as intended.

With respect to the operation of power controller 29, the AC power provided to the smart doorbell 20 by the existing home transformer typically has a voltage in the range of 16-24 VAC. The incoming AC power may be converted to DC (direct-current) by an AC/DC rectifier (not shown). An output of the AC/DC rectifier may be connected to an input of a DC/DC converter (also not show) which may step down the voltage from the output of the AC/DC rectifier from 16-24 VDC to a lower voltage of about 5 VDC, depending upon the needs of the various electronics contained within smart doorbell 20. The output of the DC/DC converter is then available for distribution by power controller 29. Power controller 29 controls, among other things, the amount of power drawn from the external power supply as well as an amount of supplemental or replacement power drawn from battery 30, to power the smart doorbell 20 and its A/V recording, communication and other functions. The power controller 29 may, for example, provide for all of the power needed by smart doorbell 20 to be drawn from the external power supply during normal operation, and detect when the button 22 is pressed and thereafter temporarily provide replacement power from the battery 30 to enable continued operation of the smart doorbell 20 despite momentary loss of external power from the external power supply. During times when the external power supply is available, the power controller 29 may also control an amount of power drawn from the external power supply to the battery 30 for recharging. An output of the power manager 29 is also connected to each of the internal components within smart doorbell 20 which require power, but such connections are not shown for case of illustration.

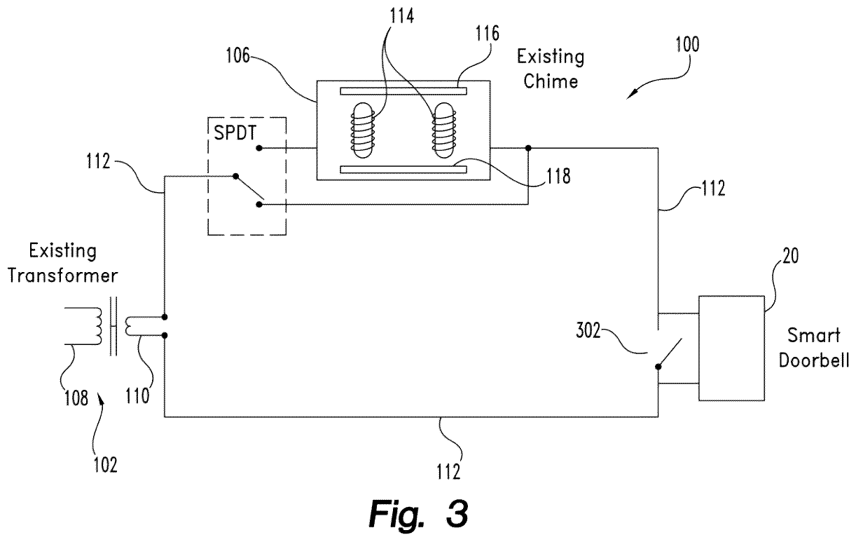

As shown better in FIG. 3, below, smart doorbell 20 also includes a switch 302 that closes when the button 22 is depressed. When the electronic switch 302 closes, power from the AC power source is temporarily at least partially diverted around the smart doorbell 20 so as to directly power the existing doorbell chime 106, as further described below. During this time continued operation of the smart doorbell is powered, at least in part, by battery 30.

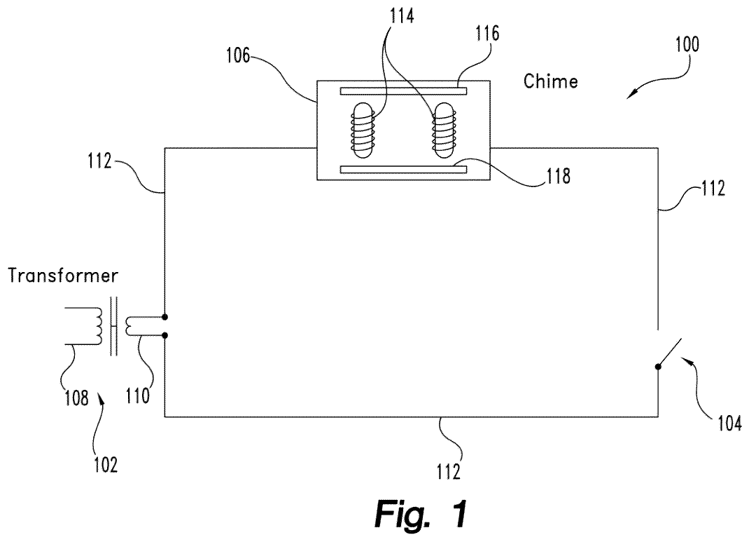

Turning now to FIG. 3, a plan view of a smart doorbell system according to one embodiment of the present invention is shown. In the illustrated form, smart doorbell 20 of FIG. 2 connects to existing household AC power supply lines 112 with switch 302 in parallel. It will be appreciated that existing components from the conventional doorbell system of FIG. 1 are commonly numbered in FIG. 3. Then, a chime controller 304 is wired into lines 112 so as to enable it to exclusively control the flow of current between either line 112a which flows across existing chime 106 or line 112b which cuts existing chime 106 entirely out of the circuit, and not merely bypassing it with lower impedance. This is important for certain existing chimes, including electronic chimes, as well as for reducing unintended current leakage. By intelligently controlling the state of chime controller 304 the existing chime 106 may be effectively maintained within the current loop when desired and removed when not needed. This enables the operation of the existing chime as intended, but avoids any inadvertent current flow through and/or operation of the chime when not desired, even though current is still being provided through lines 112 in order to power smart doorbell 20.

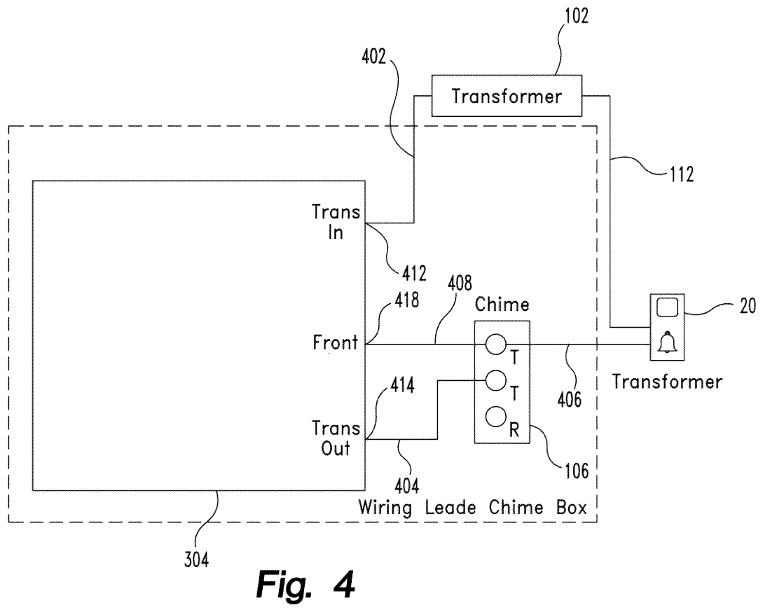

FIG. 4 illustrates a detailed view of the connections made between the existing transformer 102, the existing chime 106, the smart doorbell 20 and the chime controller 304. Traditional chimes include three connections, one labeled “TRANS” or “T” for connection to the transformer (such as existing transformer 102), one labelled “FRONT” or “F” for attachment to a front doorbell (such as existing doorbell 104) and one labelled “BACK” or B” which may be attached a second and separate doorbell. Often the chime will make a different sound (or sequence of sounds) depending upon whether the front or back doorbell was activated allowing the homeowner to immediately know which doorbell was activated.

Next the wiring of the new smart doorbell 20, including the chime controller 34, as part of a smart doorbell system 100 according to one embodiment of the present invention will be described. It shall be appreciated that the description will include a simple arrangement in which inly a front doorbell exists and the back system is unused. However, it shall be appreciated that a backdoor or second system could be installed in the same way if desired. To install the chime controller 34 for use within doorbell system 100, the wire 402 which used to connect to the “TRANS” terminal of the chime (and ran directly to the transformer 102) is instead connected to the TRANS IN” input 412 of the chime controller 304. In its place, a new wire 404 connects the “TRANS OUT” output 414 of the chime controller 304 to the “TRANS” terminal of the chime. The wire 406 which used to connect to the “FRONT” terminal (and ran to the doorbell 104) is left in place, but is jointly connected to the “FRONT” terminal of the chime with first output on the chime controller 34, which may be labelled as “FRONT” using a new wire 408. Wires 404 and 408, and/or one or more of the other wires described herein, may be integrated into or provided as part of the chime controller 404 for case of installation and/or user convenience.

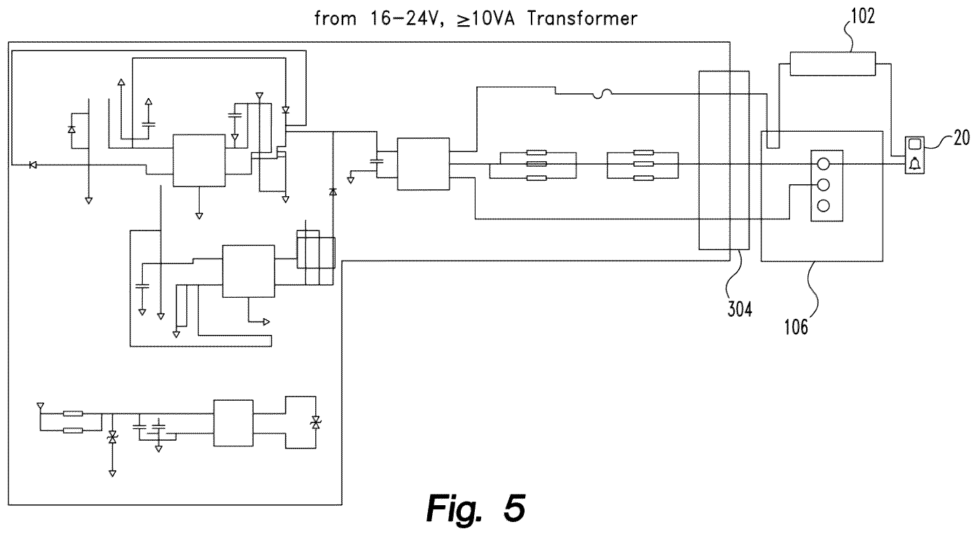

Turning to FIG. 5, a is schematic view showing the elements of a chime controller 304 in detail according to one embodiment of the present invention and its connection to certain components of the smart doorbell system, including existing transformer 102, existing chime 106 and smart doorbell 20, according to the embodiment shown in FIG. 3 is provided.

In the initial state, contacts A and B of relay U3 are closed, the switch 302 of smart doorbell 20 is open and the doorbell 20 is receiving power from the existing transformer 102. When the doorbell button 22 (shown in FIG. 3) is pressed, switch 302 closes current no longer flows into power controller 29. AC power on terminals 1 and 2 are then converted to DC power after passing through rectifier bridge U4. High logic level is generated on pin 1 of Relay U3, thereby causing Terminals A and B to open and Terminal A and C to close. This arrangement therefore electronically implements an intelligently controlled single pole double throw switch, such as a single pole dual throw relay or some other combination of electrical components. The result is that AC power is directed to the existing chime 106 through its “TRANS” and “FRONT” terminals to trigger it to make its notification sound, such as the conventional “ding” sound. When the doorbell button 22 is released, and switch 302 returns to its normally open state, current again begins to flow into power controller 29. The voltage at pin 1 and 2 quickly drops and depending upon the desired timing the input on pin 1 of Relay U3 is pulled down thereby causing Terminals A and C to open and Terminal A and B to close, thereby returning to the initial state. This disconnects the existing chime 106 from power, and may end the notification or trigger a resulting “dong” sound on a conventional chime. With power again flowing from the existing transformer 102 to the smart doorbell 20 and its power controller 29, operation of the doorbell as well as charging of batter 30 may resume until the next visitor activation of the button 22 of the smart doorbell 20 occurs.

In alternate forms, two switches or relays which are similarly controlled may be used to provide the functionality of the single throw double pole switch. The use of the term “switch” shall not imply that the component must be user actuated. Moreover, it shall be appreciated that other positionings of chime controller 34 within system 100 are contemplated for providing the same functional result.

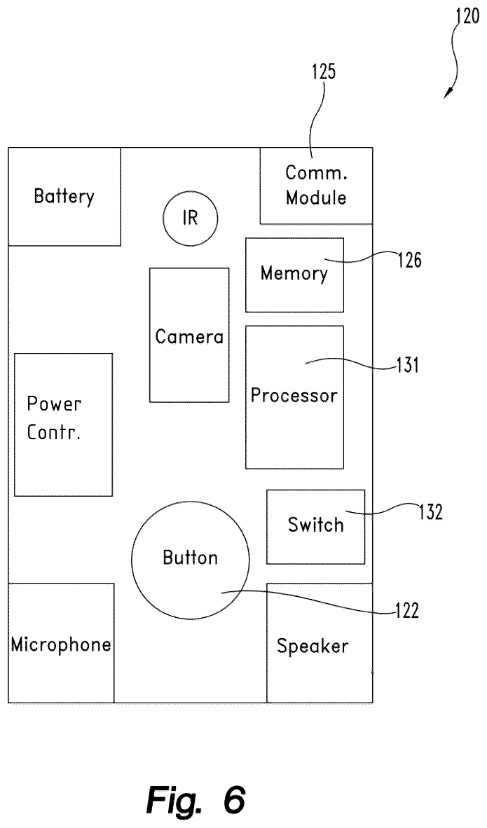

Shown in FIG. 6 is a logical view of a further embodiment of a smart doorbell 120 which may be utilized in place of smart doorbell 20 shown in FIGS. 2-5 or in accordance with the present invention. Smart doorbell 120 includes all of the components and features of smart doorbell 20, but also includes a switch 132 which is decoupled from button 122. In a conventional doorbell, the duration of time during which the doorbell button 122 is depressed by the user effects many things. For example, in a conventional doorbell such as that shown in FIG. 1, when the doorbell button is depressed the switch 104 is closed thereby closing the circuit 112 is closed and the “DING” sound is made by actuation of the plungers 114 in one direction which strikes the resonator 116. When the button is released, whether 0.1 seconds or 3 seconds later, switch 104 re-opens and the circuit 112 is opened, thus the plungers 114 return to their rest position, often striking resonator 118 in the process and making the “DONG” sound. Alternatively, when the chime is an electronic or digital chime (and lacking another power source) this may result in a notification that is insufficient in time, or at least less than desirable.

By decoupling switch 132 from button 122, the duration of the state change of the smart doorbell 120 may be controlled. As will be appreciated by one of skill in the art, numerous state changes without the doorbell circuit may be utilized and operated on to trigger the resulting notification. Under the control of processor 131, a “switch operation period” (or alternatively some other state change such as increased impedance, resistance or the like) may be programmatically defined within memory 126. This period may be defined in an appropriate timing unit, but for example may be seconds, milliseconds or the like.

As one example, a user may connect with smart doorbell 120 using a smartphone or other interface via communication module 125. Therein the user may set the “switch operation period” within memory 126. For purposes of example, the user might select 2 seconds. Accordingly, whenever button 122 is activated, processor 131 detects the event and actuates switch 132 in the appropriate manner, which in this example is to close and therefore short out the smart doorbell 120. Using stored power from battery 130, the processor continues to time and when the currently defined “switch operation period” elapses, the processor 132 returns the switch 132 to its normal state of operation, which in this example is open. This process and timing occurs regardless of how long the user keeps the button 122 depressed and repeated upon each activation. In one form, a second depression of the button 122 prior to the end of the “switch operation period” trigger by a prior depression would have no effect. In an alternate form, a second depression would temporarily increase the “switch operation period.”

The “switch operation period” enables a user to customize and received a consistent notification sound, whether utilizing a conventional mechanical doorbell or a more modern digital doorbell. The ability to have this timing adjusted increased the compatibility of the smart doorbell 120 with other existing and potential new systems as well as elevates the user experience.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A smart doorbell system, comprising:
a smart doorbell having a button, a camera, a wireless communication module and a power bypass, wherein the smart doorbell is connected to an external power source and the button enables a visitor to sound a doorbell chime;
a chime controller including a single pole dual throw switch assembly electrically connected to the smart doorbell, the external power source and the doorbell chime, wherein the single pole dual throw switch assembly is operable between a first state and a second state;
wherein the first state provides power to the smart doorbell by supplying power from the external power source without providing power to the doorbell chime; and
wherein the second state provides power to the doorbell chime by supplying power from the electrical power source through the power bypass of the smart doorbell.

2. The smart doorbell system of claim 1, wherein the chime controller controls the single pole dual throw switch assembly based upon detecting when the smart doorbell is drawing power or when power flows through the power bypass.

3. The smart doorbell system of claim 2, wherein the smart doorbell is configured such that pressing the button of the smart doorbell causes the smart doorbell to direct power through the power bypass.

4. The smart doorbell system of claim 1, wherein the chime controller controls the single pole dual throw switch assembly based upon when the button of the smart doorbell is depressed.

5. The smart doorbell system of claim 1, wherein the single pole dual throw switch is implemented using at least one relay.

6. The smart doorbell system of claim 1, wherein the doorbell chime is a mechanical chime having at least one solenoid and at least one resonator.

7. The smart doorbell system of claim 1, wherein the smart doorbell further comprises a battery for powering the smart doorbell when the single pole dual throw switch when the power bypass is active.

8. The smart doorbell system of claim 1, wherein the external power supply is a transformer which provides between 6 and 36 volts.

9. The smart doorbell system of claim 8, wherein the external power supply is a transformer which provides between 10 and 24 volts.

10. The smart doorbell system of claim 1, wherein the smart doorbell is indirectly connected to an external power source.

11. A system configured to selectively electrically power a smart doorbell and a doorbell chime, the system comprising:
a smart doorbell;
an external power supply; and
a chime controller electrically coupled to the smart doorbell and the doorbell chime, wherein the chime controller includes a single pole dual throw switch normally receiving a baseline electricity from the external power supply at its input and passing the first electricity to its first output to flow through the smart doorbell and not the doorbell chime, and
wherein in response to the chime controller receiving a second electricity that is distinct from the first electricity, the chime controller signals the single pole dual throw switch receiving the second electricity at its input to change states to pass the second electricity to its second input to flow through the chime.

12. The system of claim 11, wherein the second electricity is greater than the first electricity.

13. The smart doorbell system of claim 11, wherein the smart doorbell is configured such that pressing the button of the smart doorbell causes the smart doorbell to direct power through the power bypass.

14. The smart doorbell system of claim 13, wherein the chime controller controls the single pole dual throw switch assembly based upon when the button of the smart doorbell is depressed.

15. The smart doorbell system of claim 11, wherein the single pole dual throw switch is implemented using at least one relay.

16. The smart doorbell system of claim 11, wherein the doorbell chime is a mechanical chime having at least one solenoid and at least one resonator.

17. A smart doorbell system, comprising:
a smart doorbell having a button, a processor, a memory and a wireless communication module, wherein the smart doorbell is connected to an external power source and the button enables a visitor to cause a change between a first electrical condition and a second electrical condition on a doorbell circuit;
the processor operable to store in the memory a predetermined time duration;
the process further operable to detect an activation of the button and respond by changing from the first electrical condition to the second electrical condition on the doorbell circuit, waiting for a period of time corresponding to the predetermined time duration, and changing from the second electrical condition to the first electrical condition on the doorbell circuit.

18. The smart doorbell system of claim 17, further comprising a doorbell chime and a chime controller, wherein the change between a first electrical condition and a second electrical condition on the doorbell circuit cause the chime controller and the doorbell chime to sound an audible visitor notification.

19. The smart doorbell system of claim 17, wherein the change between a first electrical condition and a second electrical condition on the doorbell circuit is caused by the activation of a switch or relay within the smart doorbell that is controlled by the processor.

20. The smart doorbell system of claim 17, wherein the predetermined time duration is received as a user input via the wireless communication module.
